(19) United States
(12) Patent Application Publication
(10) Pub. No.: US 2007/0256310 A1
(43) Pub. Date: Nov. 8, 2007

(54) Utility Knife With Cam Clamping Means

(76) Inventors: Dan B. Pool, Scottsdale, AZ (US); George Jeffery Mowry, Mesa, AZ (US)

Correspondence Address: VENABLE, CAMPILLO, LOGAN & MEANEY, P.C., 1938 E. OSBORN RD, PHOENIX, AZ, 85016-7234, US

(21) Appl. No.: 11/743,456

(22) Filed: May 2, 2007

Related U.S. Application Data
(60) Provisional application No. 60/796,953, filed on May 2, 2006.

(51) Int. Cl. B26B 3/00

(52) U.S. Cl. 30/339; 30/125

(57) ABSTRACT

An utility knife and method of blade removal in a utility knife comprising releasing a cam pressure using a lever on a fastener holding a first half and a second half of a handle of a utility knife; separating the first half and second half; and rotating the first half from the alignment with the second half to allow a blade to be removed are shown.

The present invention relates to the field of cutting tools. Particularly, it relates to cutting tools such as utility knifes with replaceable blades. In one preferred embodiment, it relates to a utility knife with a fixed, clamped blade of the style often used by drywall hanging professionals.

### BACKGROUND

Cutting tools with replaceable blades are well known and are generally referred to as utility knives. Generally, utility knife designs require a closing mechanism of some sort to hold the halves of the knife together. This closing mechanism is typically a threaded screw, requiring a screwdriver or similar tool simply to replace the blade.

There is a need to improve the mechanical properties of the utility knife such that the closing mechanism does not need an additional tool, is easy to use and has a quick release.

Information relevant to utility knives can be found in U.S. Pat. Nos. 3,509,627 (Gilbert et al.), 3,660,895 (West), 4,068,375 (Rathbun et al.), 4,524,518 (West), 4,604,805 (Krieger), 4,939,839 (Gorst), 5,005,290 (Gilbert), 5,022,156 (Kallens et al.), 5,301,428 (Wilcox), 5,404,645 (Janser), 5,862,596 (Chung), 5,864,952 (Chung), 5,878,501 (Owens et al.), 6,026,575 (Haung), 6,223,439 (Wonderley) and 6,971,178 (Rowlay). Each of the foregoing United States patent is incorporated herein by reference. Each one of these referenced items, however, suffers from one or more of the needs cited above.

For example, one disadvantage is that the closing mechanism having a screw thread requires an additional tool.

For example, another disadvantage is that the threaded screw may be lost if removed.

### SUMMARY

It is an object of the present invention in one embodiment to allow blades to be replaced with the movement of a lever. The lever has a cam lobe and pivot at its end, allowing force to be applied to the two halves of the knife and the blade without the need for a threaded closing mechanism.

It is a further object of the present invention in one embodiment to provide a utility knife for mounting a blade comprising a lever having a cam with an eccentric rotation axis; a handle for the utility knife comprising: a first half having a recessed pocket and a first slot, a second half having a forward inner section wherein a blade is mounted to extend at least partially past the forward inner section; and a fastener comprising a first end and a second end; wherein the fastener is coupled to the second half and the first end of the fastener passes through the first slot and rotatably couples to the cam of the lever; and wherein the first half and the second half couple and uncouple by the force of the cam movement. Preferably, in this embodiment, the first half further comprises a first interlocking lobe and a first lobe coupler at a forward section and the second half further comprises a second interlocking lobe and a second lobe coupler at a forward section wherein the first interlocking lobe and second lobe coupler matingly couple and the second interlocking lobe and the first lobe coupler matingly couple. Also, preferrably, the second half further comprises at least one rear interlocking alignment rib wherein the at least one interlocking alignment rib couples to the first half for alignment thereof, and more preferably yet, the at least one rear interlocking alignment rib comprises four interlocking alignment ribs.

In yet another preferred embodiment, the second half further comprises a blade support made of magnetic material. Likewise in a preferred embodiment, the second half may further comprise a second slot wherein the fastener passes before passing through the first slot, and more preferably the second end of the fastener further comprises a rectangular portion.

Most preferably, the invention may further comprise a spring placed between the second half and first half through which the fastener passes, comprising a friction plate having a friction slot and an alignment tooth and wherein the first half further comprises a first recessed portion adapted to receive the friction plate, and the second recessed portion further comprises spacing ribs.

Another preferred embodiment of the invention provides a method of blade removal in a utility knife comprising: releasing a cam pressure using a lever on a fastener holding together a first half and a second half of a handle of a utility knife; separating the first half and second half; and rotating the first half from the alignment with the second half to allow a blade to be removed.

Another preferred embodiment of the invention may comprise a utility knife for mounting a blade including a lever having a cam with an eccentric rotation axis; a handle for the utility knife comprising: a first half having a recessed pocket and a first slot, a second half having a forward inner section wherein the blade is mounted to extend at least partially past the forward inner section, and a fastener comprising a first end and a second end wherein the fastener is connected to the second half and coupled to the first end of the fastener that passes through the first slot and rotatably couples to the cam of the lever; and wherein the first half and the second half couple and uncouple by the force of the cam movement

### BRIEF DESCRIPTION OF THE DRAWINGS

FIG. 1 is a perspective top view of one preferred embodiment of a utility knife including a blade.

FIG. 2 is a perspective bottom view of one preferred embodiment of a utility knife including a blade.

FIG. 3a is a perspective top view of one preferred embodiment of a utility knife including a blade with a lever in an up open position.

FIG. 3b is a perspective top view of one preferred embodiment of a utility knife including a blade with a lever in an up and reversed open position.

FIG. 4 is a perspective top view of one preferred embodiment of a utility knife in an open position.

FIG. 5 is an exploded side top view of one preferred embodiment of a utility knife.

FIG. 6 is an exploded side bottom view of one preferred embodiment of a utility knife.

FIG. 7 is a side view of one preferred embodiment of a lever side of a utility knife showing a line A-A.

FIG. 8 is a cross-sectional view of one preferred embodiment of a lever side of a utility knife taken along the line A-A in FIG. 7.

FIG. 9 is a side view of one preferred embodiment of a lever side of a utility knife in a closed position showing a line B-B.

FIG. 10 is a cross-sectional view of one preferred embodiment of a lever side of a utility knife taken along the line B-B in FIG. 9.

FIG. 11 is a side perspective view of one preferred embodiment of a non-lever side showing a specific section C.

FIG. 12 is an enlarged view of one preferred embodiment of a non-lever side showing the section C in detail.

### DESCRIPTION OF PREFERRED EMBODIMENTS

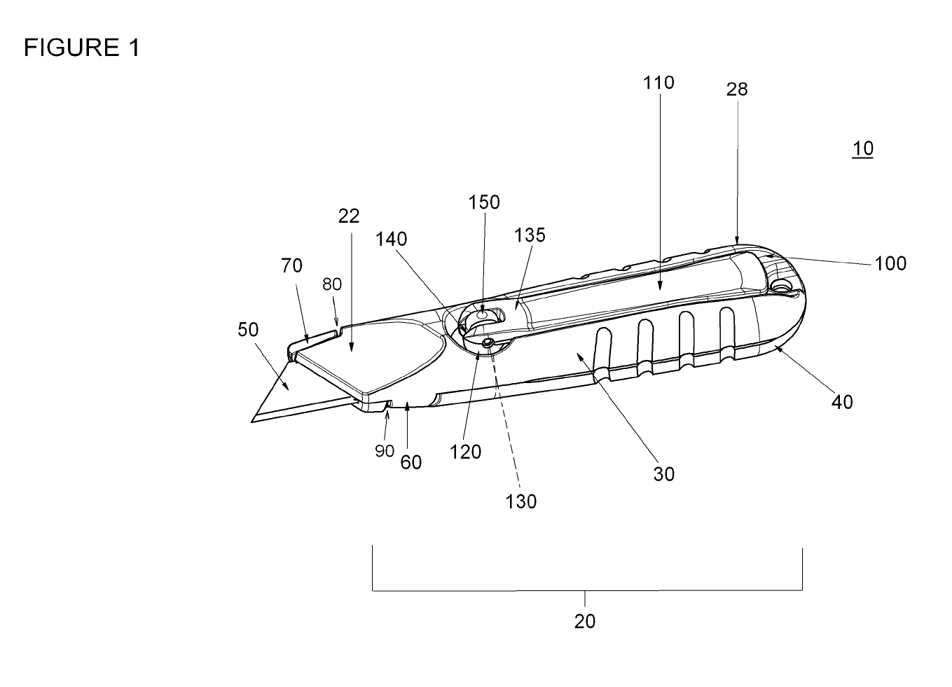

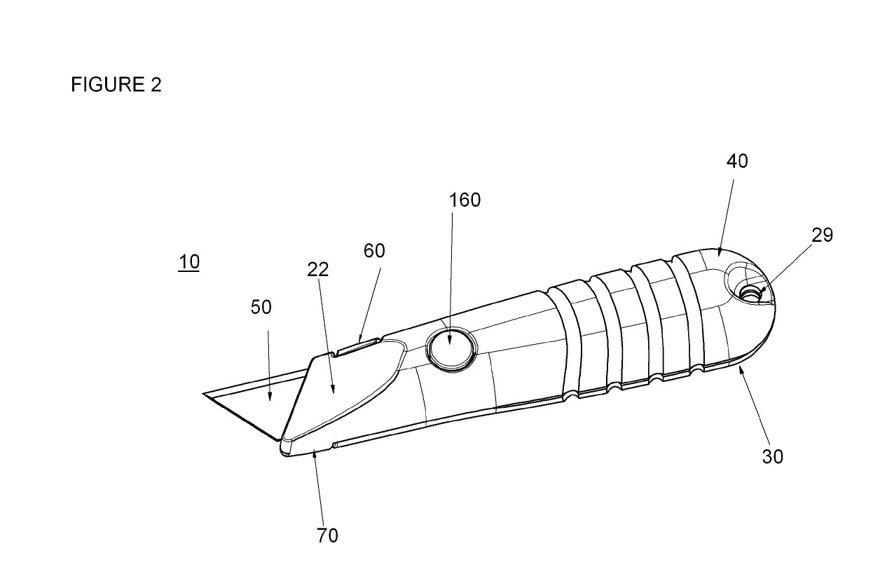

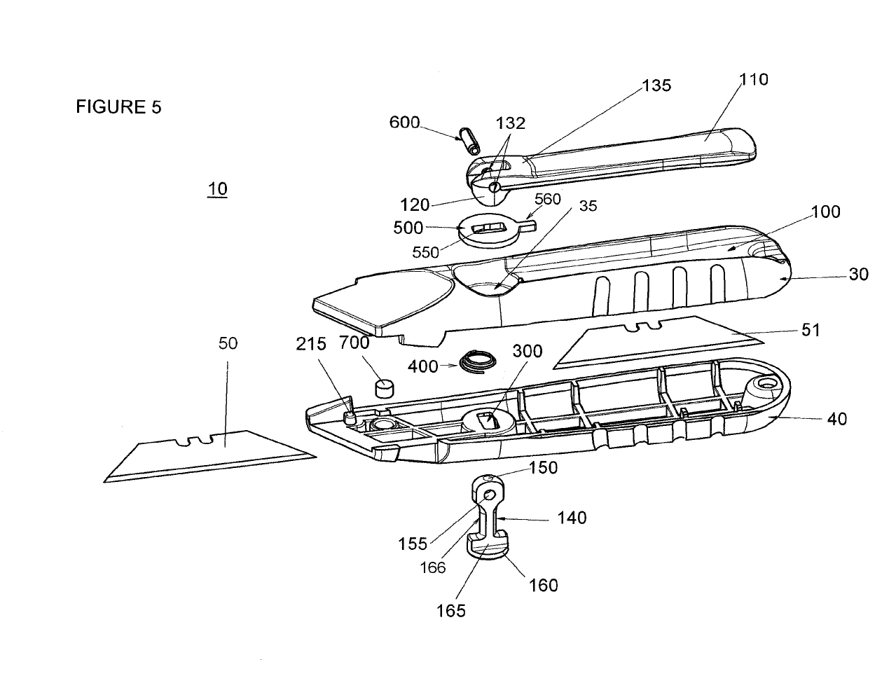

Turning now to the drawings in which like reference characters indicate corresponding elements throughout the several views, attention is first directed to FIGS. 1 and 2 which show a perspective top and bottom view of a utility knife 10 incorporating one preferred embodiment of the invention generally comprising a substantially hollow handle 20 having a forward section 22 and rear section 28 comprising a first half 30 and a second half 40 which receive the blade 50. The exterior of the handle 20 is suitably shaped to facilitate manual holding of handle 20 and use of the utility knife 10 to perform various cutting tasks using the blade 50. The first half 30 and the second half 40 have opposed interlocking lobes, a first interlocking lobe 60 and a second interlocking lobe 70, respectively, that, in this preferred embodiment, are located on the forward section 22 of the handle 20. First interlocking lobe 60 and second interlocking lobe 70 matingly couple respectively with a second lobe coupler 90 and a first lobe coupler 80 when the first half 30 and second half 40 are coupled in a closed position. In this preferred embodiment, the first half 30 comprises a recessed pocket 100 in which the lever 110 including a cam 120 having an eccentric rotation axis 130 at one end 135 that is adapted to matingly couple about to a fastener 140 having a first end 150 and a second end 160, as shown in FIG. 5, wherein the second end 160 is coupled to the second half 40 and the first end 150 is coupled to the cam 120 such that the lifting of the lever 110 from the recessed pocket 100 relieves the pressure from the first half 30 and the second half 40 of the handle 20 and the blade 50 to allow the first half 30 and the second half 40 to open for blade 50 change or retrieval. While the second end 160 of the fastener 140 may be integral or connected to second half 40, preferably the fastener 140 extends through both the second half 40 and the first half 30 along a fastening axis. Closing the handle 20 merely reverses the process.

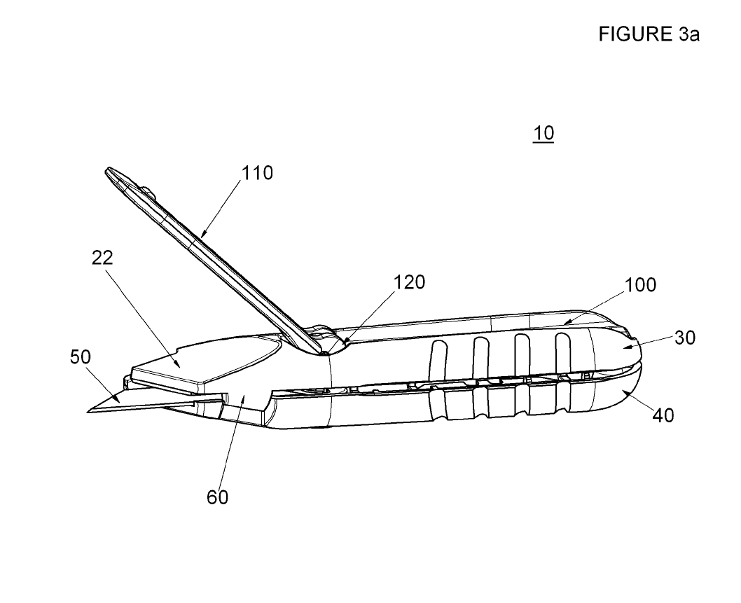

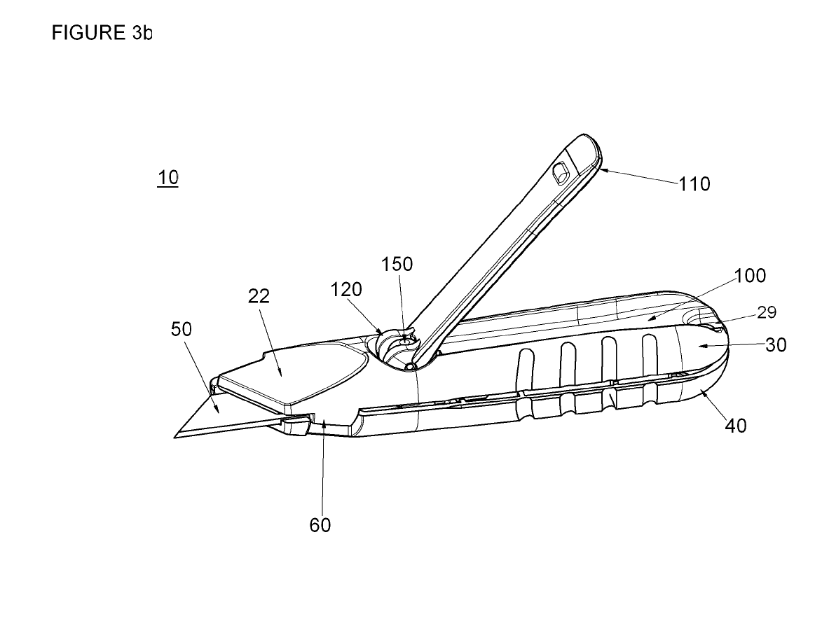

FIG. 3a shows a preferred embodiment where the lever 110 has been lifted from the recessed pocket 100. FIG. 3b shows a preferred embodiment where the lever 110 has been lifted from the recessed pocket 100 and then rotated about the fastening axis such that the cam 120 is not directed toward the first half if the lever 110 is returned to the recessed pocket 100. In a more preferred embodiment, the rear section 28 has an attachment hole 29 so that a cord, strap or wrist strap may be attached.

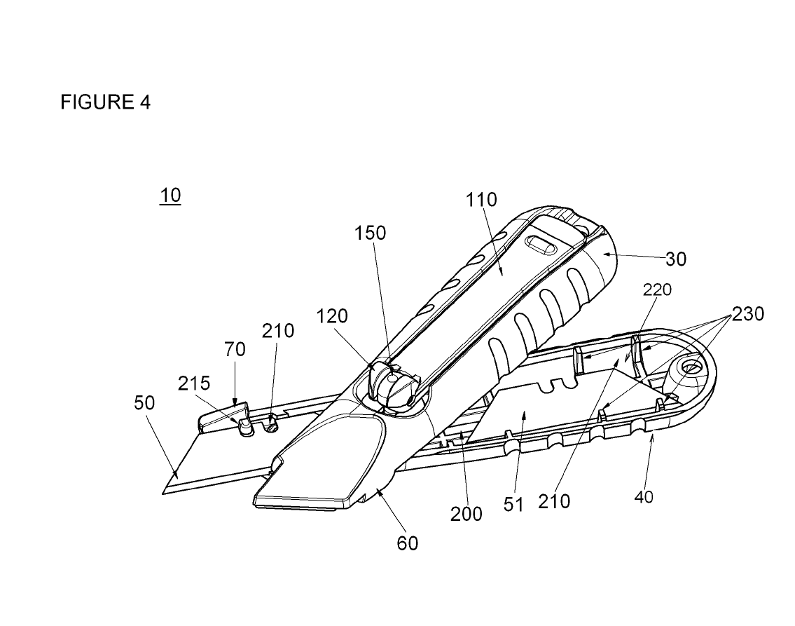

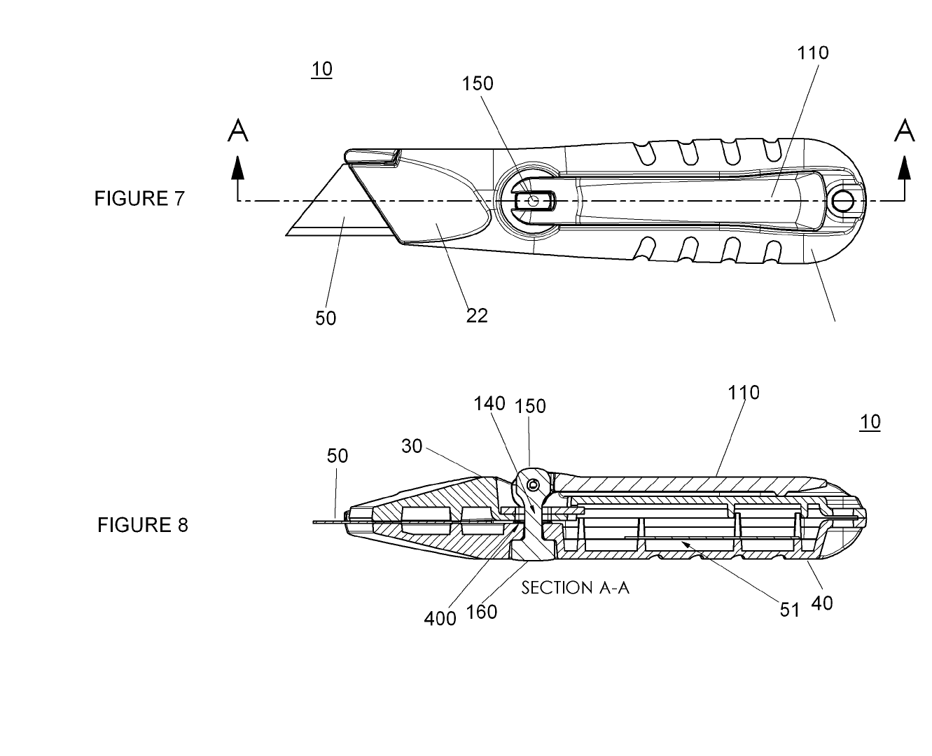

The first half 30 and the second half 40 are pivotally movable in a swivel-like motion around the fastening axis between the closed position shown in FIGS. 1, 2, 3a and 3b and the open position illustrated in FIG. 4. In a closed position, the first half 30 and second half 40 cooperate to form the utility knife 10 comprising a handle 20 and a blade 50. The blade 50 may be of any kind used in utility knives, but is preferably a trapezoidal type having a notch or a plurality of notches. In the preferred embodiment shown in FIG. 4, the second half 40 has an inside section 200 including a forward inside section 210 having a blade rib 215 and a rear inside section 220 and at least one rear interlocking alignment rib 230, and preferably four rear interlocking alignment ribs 230. In this preferred embodiment, the blade 50 is mounted in forward inside section 210 such that blade rib 215 cooperates with a notch in the blade 50 to define the longitudinal projection of the blade 50 beyond the forward inside section 210 (and the forward section 22 when the handle 20 is in the closed position) such that the cutting surface of blade 50 may be used for cutting. In this preferred embodiment, additional blades 51 may be placed in the rear inside section 220 for carrying and later use. FIGS. 7 though 10 show the preferred embodiment of the invention in cross section when closed.

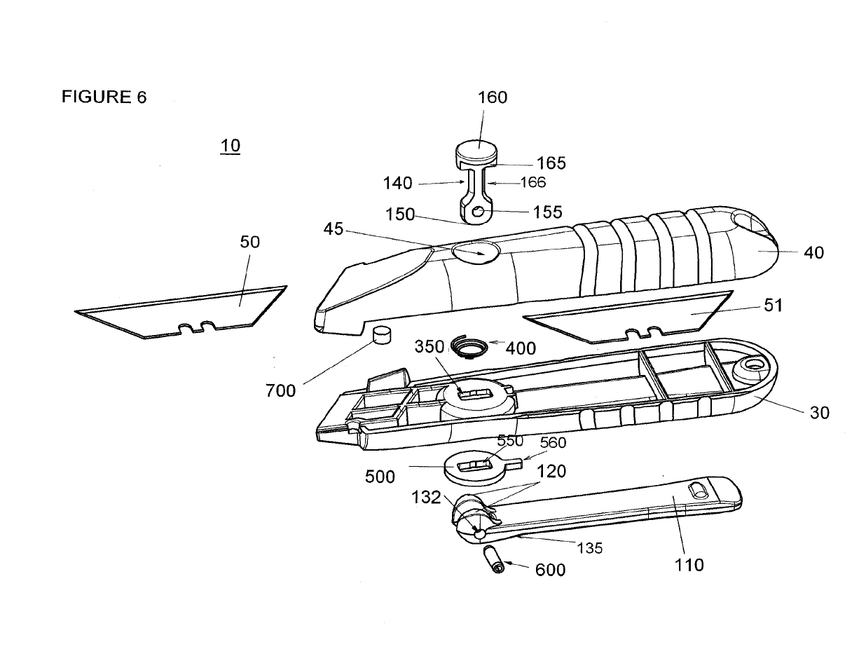

FIGS. 5 and 6 show exploded views of a preferred embodiment of the invention. In addition to the elements described in FIGS. 1-4, this preferred embodiment shows additional preferred elements and details. The preferred embodiment shown in FIGS. 5 and 6 include the fastener 140 having a second end 160 which is round and a rectangular portion 165 extending therefrom to a cylindrical portion 166 and to the first end 150 having first end hole 155 therein and which is more preferably rounded or blunt. FIGS. 5 and 6 additionally show the second half 40 having a second recessed portion 45 having a second slot 300 substantially perpendicular to the longitudinal axis of the second half 40 and an optionally preferred blade support 700 that can be used to clamp the blade 50 when the utility knife is to be used as a fixed, clamped blade style. More preferably the blade support 700 is made of magnetic materials such that it may removably couple with the blade 50 to hold it in place. Additionally, FIGS. 5 and 6 show an optional spring 400, a friction plate 500 having a friction plate slot 550 and an alignment tooth 560, coupler 600, and lever 110 having offset holes 132 in the cam 120 at the front end 135. Likewise, FIGS. 5 and 6 show the first half 30 having a first recessed portion 35 having a first slot 350 substantially parallel to the longitudinal axis of the first half 30 and adapted to receive the friction plate 500. In this preferred embodiment, fastener 140 is of the appropriate size, except for second end 160, to pass through, in order, the second slot 300, the spring 400, the first slot 350 and, the friction plate 500 such that the rectangular portion 165 is perpendicular to the longitudinal axis of the second half 40 and coupled to lever 110 such that the coupler 600 passes through both offset holes 132 and first end hole 155 such that that lever 110 is movably coupled to the fastener 140. In this preferred embodiment, the height of the rectangular portion 165 is chosen such that when the handle 20 is in the closed position and the lever 110 is moved into the recessed pocket 100, it is substantially perpendicular to the second slot 300 and the height is sufficient to cause the first half 30 and second half 40 to be pressed together thereby clamping the blade 50 in place.

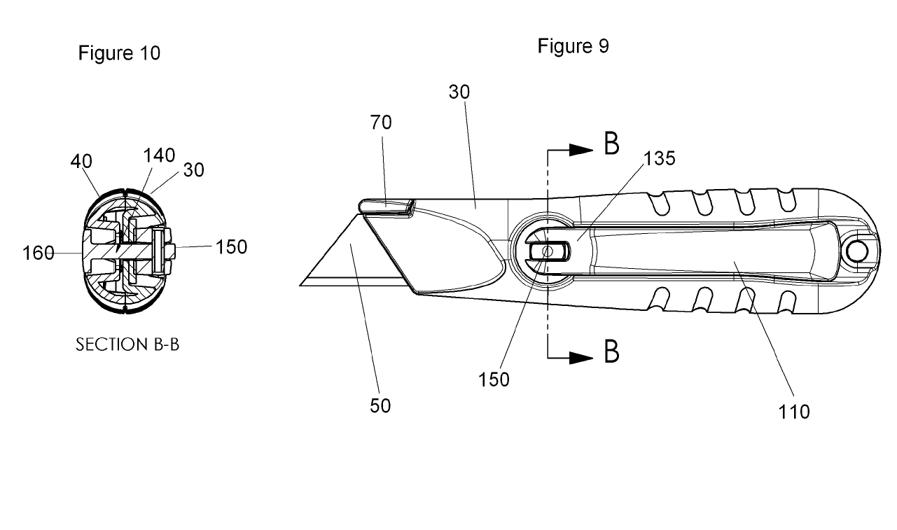

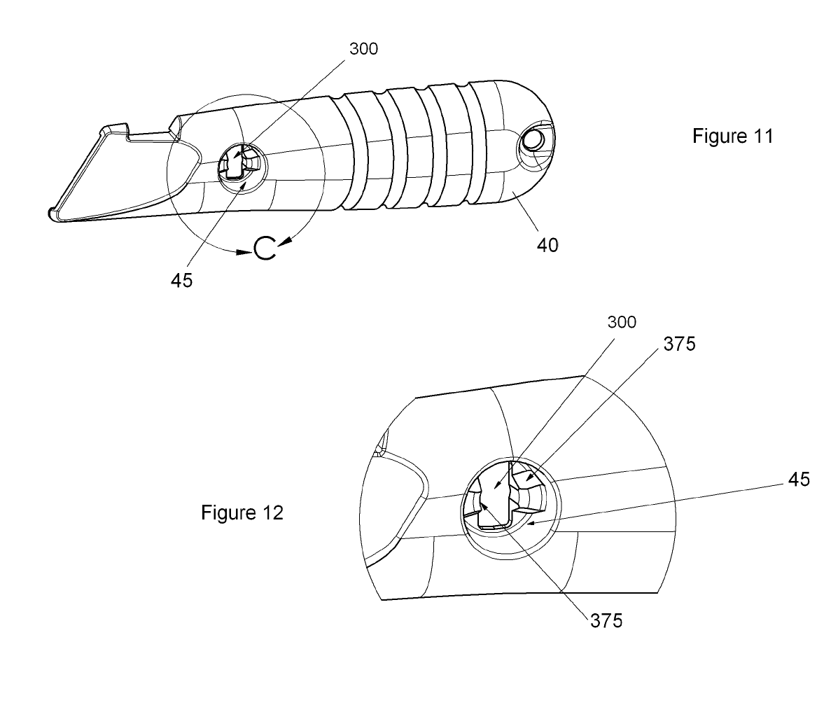

FIGS. 7 and 8 show a side view of a preferred embodiment of the invention and a longitudinal cross-section taken along the axis A-A. Similarly, FIGS. 9 and 10 show a side view of a preferred embodiment of the invention and a transverse cross-section taken along the axis A-A. FIGS. 11 and 12, show an additional preferred embodiment of the second half 40 including a second recessed portion 45, a second slot 300, and an additional two spacing ribs 375. In this preferred embodiment, the second slot 300 is substantially perpendicular to the longitudinal axis of the second half 40 and the spacing ribs 375 are parallel to the longitudinal axis of the second half 40 and are located on either side of the center of the second slot 300. The spacing ribs 375 provide additional spacing for the fastener 140 by interacting with the rectangular portion 165 depending on which way the fastener 140 is turned.

The utility knife 10 may be made of any material with sufficient strength such as metals, plastics or composites. The handle 20 should be made of a material with sufficient strength to transfer the clamping force to the blade 50 without collapse, but preferably a degree of flex within is desired such that the cam does not seize. More preferably, the first half 30 and second half 40 are commonly made of cast metal (aluminum or zinc), and most preferably aluminum for the light weight and feel and ability to take a variety of finishes (paint, powder coat, polish, anodizing, etc.). Preferably, the lever 110 is made of made of a molded plastic (such as nylon or glass-fiber-reinforced nylon) having the advantage of being molded in colors and are also typically inexpensive to create while holding tight tolerance. More preferably, the lever 110 is made of made of a cast metal (aluminum preferred). Preferably, the fastener 140 is made of a high tensile strength material such as metal or plastics; for example steel, aluminum or nylon material plastics. Preferably, the friction plate 500 is made of a low friction material such as metal or plastics; for example brass or bronze, or nylon or acetal (such as DELRIN) material plastics. In the preferred embodiment, the spring 400 is made of steel or other compressible material.

In another preferred embodiment of this invention, the invention could also be applied to retractable-blade utility knife designs by clamping only the two halves of the knife together without clamping the blade itself-allowing the blade to be retracted without interference from the knife halves. Likewise, a variety of additional preferred embodiments of knife handle styles can be used with this same clamping means so the utility of this idea can be expanded to all sorts of existing utility knife designs.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A utility knife for mounting a blade comprising:
A. a lever having a cam with an eccentric rotation axis;
B. a handle for the utility knife comprising:
1. a first half having a recessed pocket and a first slot,
2. a second half having a forward inner section wherein a blade is mounted to extend at least partially past the forward inner section, and
3. a fastener comprising a first end and a second end;
C. wherein the fastener is coupled to the second half and the first end of the fastener passes through the first slot and rotatably couples to the cam of the lever; and
D. wherein the first half and the second half may couple and uncouple by the force of the cam movement.

2. The utility knife as recited in claim 1 wherein the eccentric rotation axis of the cam is located at a front end of the lever.

3. The utility knife as recited in claim 1 wherein the first half further comprises a first interlocking lobe and a first lobe coupler at a forward section and the second half further comprises a second interlocking lobe and a second lobe coupler at a forward section wherein the first interlocking lobe and second lobe coupler matingly couple and the second interlocking lobe and the first lobe coupler matingly couple.

4. The utility knife as recited in claim 3 wherein the second half further comprises at least one rear interlocking alignment rib wherein the at least one interlocking alignment rib couples to the first half for alignment thereof.

5. The utility knife as recited in claim 4 wherein at least one rear interlocking alignment rib comprises four interlocking alignment ribs.

6. The utility knife as recited in claim 4 wherein the second half further comprises a blade support made of magnetic material.

7. The utility knife as recited in claim 1 wherein the second half further comprises a second slot wherein the fastener passes before passing through the first slot.

8. The utility knife as recited in claim 7 wherein the second end of the fastener further comprises a rectangular portion.

9. The utility knife as recited in claim 8 further comprising a spring placed between the second half and first half through which the fastener passes.

10. The utility knife as recited in claim 8 further comprising a friction plate having a friction slot and an alignment tooth and wherein the first half further comprises a first recessed portion adapted to receive the friction plate.

11. The utility knife as recited in claim 8 wherein the second recessed portion further comprises spacing ribs.

12. A method of blade removal in a utility knife comprising: releasing a cam pressure using a lever on a fastener holding together a first half and a second half of a handle of a utility knife; separating the first half and second half; and rotating the first half from the alignment with the second half to allow a blade to be removed.

13. A utility knife for mounting a blade comprising:
A. a lever having a cam with an eccentric rotation axis;
B. a handle for the utility knife comprising:
1. a first half having a recessed pocket and a first slot,
2. a second half having a forward inner section wherein the blade is mounted to extend at least partially past the forward inner section; and
C. a fastener comprising a first end and a second end wherein the fastener is connected to the second half and coupled to the first end of the fastener passes through the first slot and rotatably couples to the cam of the lever; and
D. wherein the first half and the second half may couple and uncouple by the force of the cam movement.

14. The utility knife as recited in claim 13 wherein the eccentric rotation axis of the cam is located at a front end of the lever.
